(19) United States
(12) Patent Application Publication
(10) Pub. No.: US 2016/0099521 A1
(43) Pub. Date: Apr. 7, 2016

(54) POLARIZED ELECTRICAL PLUG AND ADAPTOR WITH ORIENTATION VERIFICATION

(71) Applicant: Michael S. Gzybowski, Ann Arbor, MI (US)

(72) Inventor: Michael S. Gzybowski, Ann Arbor, MI (US)

(21) Appl. No.: 14/971,042

(22) Filed: Dec. 16, 2015

Related U.S. Application Data
(63) Continuation-in-part of application No. 14/709,713, filed on May 12, 2015.
(60) Provisional application No. 62/019,500, filed on Jul. 1, 2014.

(51) Int. Cl. H01R 13/64; H01R 24/28

(52) U.S. Cl. CPC H01R 13/64; H01R 24/28; H01R 2103/00

(57) ABSTRACT

A two-prong polarized electrical plug adaptor and a method of confirming proper orientation of a two prong polarized electrical plug with respect to a polarized electrical receptacle or outlet before and after being plugged into the outlet which method includes the steps of: providing a two-prong polarized electrical plug adaptor to which a two-prong polarized electrical plug is coupled; providing an indicia element on the top of the plug adaptor which provides visual confirmation of proper orientation with respect to a polarized electrical receptacle or outlet before and after being plugged into the outlet; providing a polarized electrical receptacle or outlet; and visually confirming that the indicia element is pointing upward when and/or after the plug adaptor is inserted into the polarized electrical receptacle or outlet.

### RELATED APPLICATION

This application is a continuation-in-part application of U.S. patent application Ser. No. 14/709,713, filed May 12, 2015 which was in turn based on U.S. Provisional Application Ser. No. 62/019,500, filed Jul. 1, 2014 to each of which priority is claimed under 35 U.S.C. §120 and of each of which the entire specifications are hereby expressly incorporated by reference.

### BACKGROUND

The present invention relates generally to two-prong polarized electrical plugs and more particularly to two-prong polarized electrical plugs that are provided with visible indicia that assists in orienting such plugs with respect to polarized electrical outlets or receptacles and verifying the proper orientation and safety of such plugs with respect to polarized electrical receptacles and outlets. Further the present invention generally relates to two-prong electrical plug adaptors that are provided with visible indicia that assists in orienting such plugs with respect to polarized electrical outlets or receptacles and verifying the proper orientation and safety of such plugs with respect to polarized electrical receptacles and outlets.

Most modern electrical plugs that contain only two prongs have one prong that is wider than the other; this type of plug is said to be “polarized.” Polarized plugs are designed so that their attached electrical cords cannot be connected into a polarized receptacle or outlet the wrong way. Proper connection serves as a safeguard against electrical shock and shortage.

Where a building wiring system defines a “neutral” conductor that is connected to earth, it is an advantage for appliance designers to preserve that distinction. This requires a plug that should only be connected in one way to an outlet or receptacle, so that the energized and neutral conductors are not interchanged. In most designs, such “polarized” plugs are designed so that they cannot be easily mated with non-polarized outlets or receptacles.

In most cases polarization can be maintained by the shape, size, and/or position of plug pins and socket holes to ensure that a plug fits only one way into an outlet or receptacle. The (single pole) switch of the appliance is then connected in series with the energized wire. For an appliance such as a toaster, putting the exposed heating wires on the neutral side of the switch provides extra protection against electrical shock; similarly, lamps with Edison screw bases will connect the screw shell of the lamp socket to the neutral conductor.

An electrical device with an on/off switch typically has a polarized plug so that the switch opens the energized line of the circuit. If the plug were inserted backwards into a polarized outlet, turning the switch to the “off” position would not de-energize the device; it would just stop it from working. If the plug is reversible, the appliance will still work, but the components will be energized, even when the switch is off. Therefore an insect, rodent or foreign object can cause a short circuit, even with the switch off, if the polarity is reversed.

The width difference in the prongs or blades of a standard two-prong polarized electrical plug is only 0.062 inches (0.312 inches for the polarized prong or blade and 0.250 inches for the non-polarized prong or blade). This slight difference in width generally requires a visual comparison between the prongs or blades in order to determine the proper orientation required to plug a two-prong polarized electrical plug into a polarized outlet or receptacle.

The visual identity of the polarized prong or blade of a two-prong polarized electrical plug can require adequate lighting, which can be a problem when trying to plug in the two-prong polarized electrical plug of a lamp or other electrical device in a dimly lit or dark room. Further the visual identity of the polarized prong or blade of a two-prong polarized electrical plug requires viewing the prongs or blades from a side direction, whereas one generally views such plugs from the top when inserting them into electrical outlets or receptacles. For persons with poor eyesight it can be much more difficult to identify the orientation of a polarized plug.

Because the thickness and lengths of the prongs or blades of a two-prong polarized electrical plug are the same, it is not possible to visually determine which is the polarized (wider) prong or blade when looking downward on the plug when attempting to insert it into an electrical outlet or receptacle.

As a result, most people have often experienced attempts at plugging two-prong polarized electrical plugs into outlets or receptacles only to encounter resistance and then have to turn the plugs over to have the polarized prong or blade properly orientated in alignment with the outlet or receptacle, or force the plugs into the outlet or receptacle in an improper orientation.

Such use problems can be even more complex when trying to plug a two-prong polarized electrical plug into an outlet or receptacle that has limited access such as one located behind or under a piece of furniture or when the electrical outlet or receptacle is at a low position and the user has difficulty bending over.

FIG. 1A is a prospective view of a common, standard two-prong polarized electrical plug. FIG. 1B is a top planar view of the polarized plug of FIG. 1A. FIG. 1C is a bottom planar view of the polarized plug of FIG. 1A. The plug includes a polarized prong or blade 1 and a non-polarized prong or blade 2 extending outward from a front face 3 of the plug housing 4. An electrical cord 5 extends out from the rear of the plug housing 4 and can be connected to an electrical appliance or an outlet of an extension cord.

The top half 6 and bottom half 7 of the plug housing 4 in FIG. 1 are symmetrical about a plane that bisects the top and bottom halves. As such the top and bottom of the plug housing 4 look identical as shown in FIGS. 1B and 1C. Further since the thicknesses T and lengths L of the prongs or blades 1 and 2 (See FIG. 1B) are the same, the entire electrical plug including the plug housing 4 and prongs or blades 1 and 2 look virtually the same from the top or bottom. As a result it is difficult to readily determine the orientation of the electrical plug of FIG. 1 as regards the polarized and non-polarized prongs or blades 1 and 2 by merely looking toward the top or bottom of the plug before the plug is inserted into an outlet or receptacle. Moreover once the plug is inserted into an outlet or receptacle there no longer exist any visible structure that can be used to confirm or verify that the prongs or blades of the plug are properly aligned for safety purposes.

The present invention provides visible indicia on two-prong polarized electrical plugs that, according to one aspect of the invention, assists in orienting such plugs with respect to polarized electrical receptacles.

In some instances it is possible to inadvertently insert a two-prong polarized plug into an electrical outlet or receptacle in such an orientation that the polarized prong or blade is not received in the polarized socket of the outlet or receptacle, thus frustrating the safety provisions for which polarized systems were developed. Such instances can occur when one forces the plug into the outlet or receptacle or when the receiving socket of the outlet or receptacle is cracked or the dimensional tolerances of the polarized prong or blade or outlet socket are such as to allow improper orientation of the polarized plug in the outlet or receptacle, and sometimes when a prior user has modified the polarized prong or blade of such plugs.

Thus accordingly to another aspect of the present invention the indicia of the present invention provides a safely function that is directly associated with the polarized system in that it provides visual assurance and confirmation of proper orientation and safety of the polarized plug which might not otherwise be confirmed after the polarized plug is inserted into an outlet or receptacle.

### BRIEF SUMMARY

According to various features, characteristics and embodiments of the present invention which will become apparent as the description thereof proceeds, the present invention provides a polarized electrical plug that provides for visual confirmation of proper orientation with respect to a polarized electrical receptacle or outlet before and after being plugged into the outlet which comprises:

a plug housing having a top and a bottom and a front face;

an electrically conductive polarized prong or blade that extends outward from front face of the plug housing;

an electrically conductive non-polarized prong or blade that extends outward from the front face of the plug housing; and

an indicia element provided on the top of the plug housing which provides visual confirmation of proper orientation with respect to a polarized electrical receptacle or outlet before and after being plugged into the outlet.

The present invention further provides a method of confirming proper orientation of a two prong polarized electrical plug with respect to a polarized electrical receptacle or outlet before and after being plugged into the outlet which method comprises:

providing a two prong polarized electrical plug comprising:
a plug housing having a top and a bottom and a front face;
an electrically conductive polarized prong or blade that extends outward from front face of the plug housing;
an electrically conductive non-polarized prong or blade that extends outward from the front face of the plug housing; and
an indicia element provided on the top of the plug housing which provides visual confirmation of proper orientation with respect to a polarized electrical receptacle or outlet before and after being plugged into the outlet;

providing a polarized electrical receptacle or outlet; and

visually confirming that the indicia element is pointing upward when and/or after the plug is inserted into the polarized electrical receptacle or outlet.

The present invention also provides a polarized electrical plug that provides for visual confirmation of proper orientation with respect to a polarized electrical receptacle or outlet before and after being plugged into the outlet which comprises:

a plug housing having a top and a bottom and a front face;

an electrically conductive polarized prong or blade that extends outward from front face of the plug housing;

an electrically conductive non-polarized prong or blade that extends outward from the front face of the plug housing;

a first indicia element provided on the top of the plug housing which provides visual confirmation of proper orientation with respect to a polarized electrical receptacle or outlet having a lower grounding socket before and after being plugged into the outlet; and

a second indicia element provided on the bottom of the plug housing which provides visual confirmation of proper orientation with respect to a polarized electrical receptacle or outlet having an upper grounding socket before and after being plugged into the outlet.

The present invention further provides a two-prong polarized electrical plug adaptor that includes:

a body having a top and a bottom and a front and a back;

an electrically conductive polarized prong or blade that extends outward from the front of the body;

an electrically conductive non-polarized prong or blade that extends outward from the front of the body;

a polarized socket provided in the back of the body;

a non-polarized socket provided in the back of the body, said polarized socket and non-polarized socket being configured to receive a two-prong polarized electrical plug therein;

electrical conductive elements within the body that connect the polarized socket to the polarized prong or blade and connect the non-polarized socket to the non-polarized prong or blade; and

an indicia element provided on the top of the body which provides visual confirmation of proper orientation with respect to a polarized electrical receptacle or outlet before and after being plugged into the outlet.

The plug adaptor of the present invention is configured to receive a standard two-prong polarized plug in the back thereof so the coupled pair of the plug and plug adaptor have the indicia element which allows confirmation of the proper orientation of the plug before and after the plug adaptor is plugged into an electrical outlet or receptacle and allows retrofitting existing two-prong electrical plugs with the indicia of the present invention.

### BRIEF DESCRIPTION OF THE DRAWINGS

The present invention will be described with reference to the attached drawings which are given as non-limiting examples only, in which:

FIG. 1A is a prospective view of a common, standard two-prong polarized electrical plug. FIG. 1B is a top planar view of the polarized plug of FIG. 1A. FIG. 1C is a bottom planar view of the polarized plug of FIG. 1A.

FIG. 2A is a perspective view of a two-prong polarized electrical plug according to one embodiment of the present invention. FIG. 2B is a top planar view of the electrical plug of FIG. 2A.

FIG. 3A is a perspective view of a two-prong polarized electrical plug according to another embodiment of the present invention. FIG. 3B is a top planar view of the electrical plug of FIG. 3A.

FIG. 4A is a perspective view of a two-prong polarized electrical plug according to another embodiment of the present invention. FIG. 4B is a top planar view of the electrical plug of FIG. 4A.

FIGS. 5A and 5B are similar to the embodiment of the invention shown in FIGS. 4A and 4B except they illustrate indicia in the form of an arrow rather than a star.

FIGS. 6A-6C are top views of a plug that is designed to be used in conjunction with an electrical outlet or receptacle having a grounding socket oriented either downward or upward.

FIGS. 7A-7C are bottom views of the plug of FIGS. 6A-6B.

FIG. 8A is a perspective view showing the front side of a two-prong polarized electrical plug adaptor according to one embodiment of the present invention.

FIG. 8B is a perspective view showing the back side of a two-prong polarized electrical plug adaptor of FIG. 8A.

FIG. 8C is a top planar view of the electrical plug adaptor of FIGS. 8A and 8B.

FIG. 8D is a planar view of the back side of the electrical plug adaptor of FIGS. 8A-8C.

### DETAILED DESCRIPTION OF THE DRAWINGS AND THE PRESENTLY PREFERRED EMBODIMENTS

The present invention is directed to two-prong polarized electrical plugs that are provided with visible indicia that assist in orienting such plugs with respect to polarized electrical receptacles and assist in verifying and confirming the proper orientation and safety of such plugs with respect to polarized electrical receptacles after being inserted into electrical outlets or receptacles.

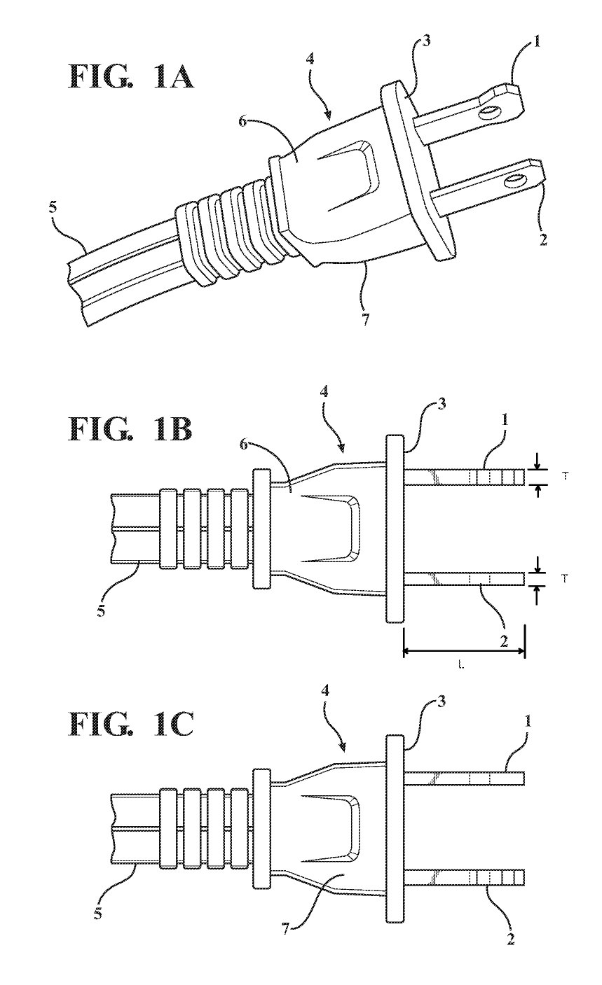

As discussed below the visible indicia can include any combination of visual colored areas or patterns, labels, stickers, decals or the like, printed colors, characters, symbols, molded, laminated, recessed laminated or embossed features other indicia that distinguishes the top of a two-prong polarized electrical plug from the bottom, permanent indicia being particularly useful. As used herein “top” refers to the area or surface of a two-prong polarized electrical plug that would be the uppermost area or surface when the plug is inserted correctly into a properly installed polarized wall mounted electrical outlet or receptacle. In one embodiment often associated with residential housing wall mounted electrical outlets or receptacles are installed with their grounding sockets toward the bottom. In such embodiments correct insertion of a two-prong polarized plug has the polarized (wider) prong or blade on the left side when viewing the plug from the back toward the front (as referenced in FIG. 1). According to another embodiment often associated with commercial facilities wall mounted electrical outlets or receptacles are installed with their grounding sockets toward the top. In such embodiments correct insertion of a two-prong polarized plug has the polarized (wider) prong or blade on the right side when viewing the plug from the back toward the front.

The present invention is particularly useful for two-prong polarized electrical plugs that have top halves and bottom halves of the plug housing that are symmetrical about plane that bisects the top and bottom halves (as illustrated in FIG. 1) in which case the tops and bottoms of the plug housing look identical, so that it cannot be readily determined from the plug housing which way to orient the plug for proper insertion into a polarized electrical outlet or receptacle of if a plug inserted into an outlet or receptacle is properly oriented for safety purposes. Otherwise the present invention is useful for two-prong polarized electrical plugs which have tops and bottoms that look the same or substantially the same absent the indicia of the present invention. In such embodiments of the present invention only the indicia provided on the top of the plug housing will allow a user to confirm the orientation of the polarized and non-polarized prongs or blades when looking onto the top of the plug before and after the plug is inserted into an electrical outlet or receptacle properly for safety purposes.

For such plugs with symmetrical top and bottom halves or otherwise having substantially visually similar top and bottom portions or halves applying or providing a color difference on the top of the plug housing or a portion of the top of the plug housing or even the top portion of the electrical cord near the plug housing would allow conventional production of such plugs with minor processing changes to include visual indicia according to the present invention.

In the case of providing embossed or molded indicia such indicia could be provided on plugs with symmetrical or visually similar top and bottom halves. Such indicia can be provided by tooling the plug molds to include such indicia or applying an embossing or stamping or heat stamping or etching process after the plug housings are molded.

Further embodiments of the present invention can provide for more dramatic visual differences between the tops and bottoms of two-prong polarized electrical plugs. For example the entire top or top half or a substantial portion (e.g. one-half, one-third or one-quarter) thereof could be a different color from the bottom or bottom half. In one embodiment the center of the top of the plug housing along a length parallel to the blades or prongs was provided with a different color from the adjacent side edges of the top. In the case of embossed or molded indicia a portion or the entire top or top half or a substantial portion (e.g. one-half, one-third or one-quarter) could be provided with a different pattern or shape than a portion or the entire bottom or bottom half.

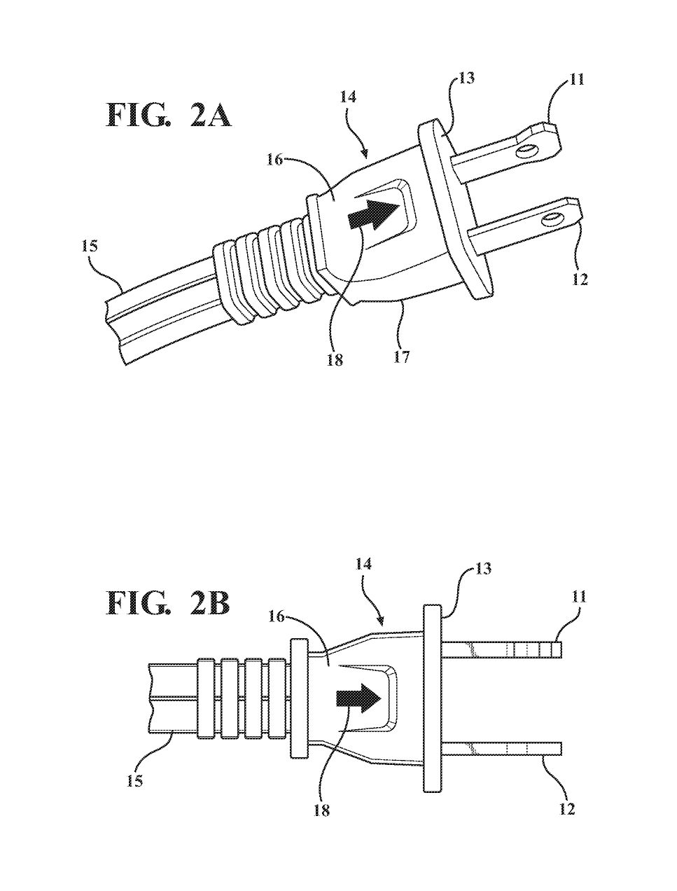

Embodiments of the present invention will be discussed and described with reference to FIGS. 2-5 which are directed to embodiments in which the plugs are configured for use with polarized electrical outlets or receptacles that have their grounding sockets toward the bottom so that the “tops” of the plugs are the areas or surfaces that face upward when prongs or blades are horizontally aligned and polarized (wider) prongs or blades on the left side when viewing the plugs from the back toward the front. It is to be understood that in other embodiments of the present invention in which the plugs are configured to be used with polarized electrical outlets of receptacles that have their grounding sockets toward the top the “tops” of the plugs are the areas or surfaces that face upward when prongs or blades are horizontally aligned and polarized (wider) prongs or blades on the right side when viewing the plugs from the back toward the front.

FIG. 2A is a perspective view of a two-prong polarized electrical plug according to one embodiment of the present invention. FIG. 2B is a top planar view of the electrical plug of FIG. 2A.

Generally the two-prong polarized electrical plug of FIGS. 2A and 2B has a similar overall shape as the standard two-prong polarized electrical plug shown in FIG. 1, it being noted that the illustrated recessed area can have the same or different shapes of be absent as in the case of similar known plugs. The plug includes a polarized prong or blade 11 and a non-polarized prong or blade 12 extending outward from a front face 13 of the plug housing 14. An electrical cord 15 extends out from the rear of the plug housing 14 and can be connected to an electrical appliance or the outlet of an extension cord (not shown). The prongs or blades 11 and 12 can be made from any conventional conductive metal such as brass and the plug housing 14 can be made (e.g. molded) from any conventional non-conductive material such as a plastic material. The electrical cord 15 comprises a two conductor cord with each conductor coupled to one of the polarized and non-polarized prongs or blades 11 and 12 within the plug housing 14 in a conventional manner.

The top half 16 and bottom half 17 of the plug housing 14 in FIGS. 2A and 2B are symmetrical about plane that bisects the top and bottom halves. Otherwise the visible top and bottom portions of the plug housing can have a similar appearance. As such, absent the indicia discussed below, the top and bottom of the plug housing 14 look identical. Further since the thicknesses T and lengths L of the prongs or blades 11 and 12 are the same (as discussed in reference to FIG. 1B), the entire electrical plug including the plug housing 14 and prongs or blades 11 and 12 looks virtually the same from the top and bottom planar views as shown in FIG. 2B. As a result one cannot determine the orientation of the electrical plug of FIG. 2 as regards the polarized and non-polarized prongs or blades 1 and 2 by merely looking towards the top or bottom of the plug—absent the indicia of the present invention. Moreover absent the indicia of the present invention one cannot confirm that a plug that has been previously inserted into and outlet or receptacle was proper oriented for safety purposes prior to being inserted.

According to the present invention an indicia element 18 is provided on (or in) the top of the plug housing 14 which functions to confirm the orientation of the polarized plug both while inserting the polarized plug into a polarized outlet receptacle and to enable confirmation of proper orientation after the polarized plug has been inserted into a polarized electrical outlet or receptacle, for example when a prior user has inserted the plug into an electrical outlet or receptacle.

The indicia element 18 depicted in FIGS. 2A and 2B is in the shape of an arrow that points toward the direction where the prongs or blades 11 and 12 extend from the plug housing 14. The arrow can be the same or a different color than the plug housing 14 so as to be easy to visually determine by most people. For example the plug housing 14 can be white and the arrow can be red, blue, black or some other color that is easily seen when compared to another color of the plug housing. That is the plug housing can generally be one color overall such as white and the indicia can be a different color such as red, blue, black, etc. or multicolored.

The arrow can be a dyed portion of the plug housing or a portion molded with a colored insert or a colored portion of the plug housing. Otherwise the arrow can be printed on the plug housing 14 or provided as a permanent label, sticker, decal, or the like provided on or laminated on or in the plug housing. In one embodiment the indicia is laminated on the surface of the plug housing or laminated in a recess formed in the plug housing using a clear resinous material or epoxy.

It is to be understood that the arrow shape shown in FIGS. 2A and 2B is for non-limited illustrative purposes only and the shape of the indicia element 18 is not necessarily limited to an arrow.

In other embodiments the indicia element 18 can have any shape such as a circle, star, plus sign, etc. Further the indicia element 18 can comprise any word like “UP” or “TOP” or any symbol, logo, or pattern, including a single line or plurality of lines.

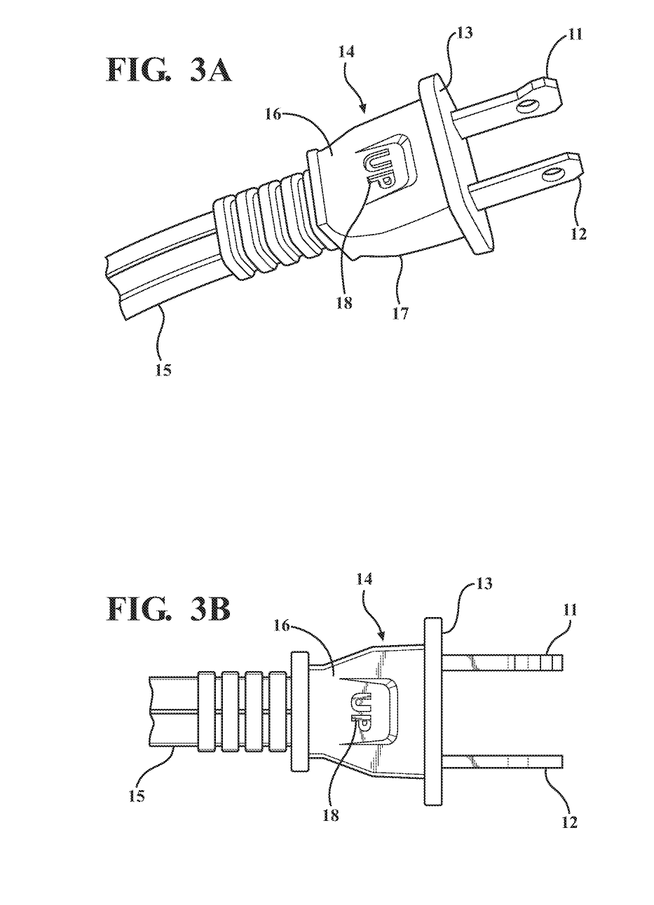

FIG. 3A is a perspective view of a two-prong polarized electrical plug according to another embodiment of the present invention. FIG. 3B is a top planar view of the electrical plug of FIG. 3A.

The two-prong polarized electrical plug of FIGS. 3A and 3B is generally similar to the two-prong polarized electrical plug of FIGS. 2A and 2B, except the indicia element 18 is formed into the plug housing 14. In this embodiment the indicia element 18 is recessed into the surface of the plug housing and can be form by molding, stamping, heat stamping, etching, including laser etching, or any suitable process. In this embodiment the indicia element 18 can be the same or a different color than the plug housing.

The shape of the indicia element 18 in FIGS. 3A and 3B is the word “UP.”

It is to be understood that the shape of the indicia element 18 shown in FIGS. 2A and 2B is for non-limited illustrative purposes only and the shape of the indicia element 18 is not limited to the word “UP.”

In other embodiments the indicia element 18 can have any shape such as an arrow, a circle, star, plus sign, etc. or be other words like “TOP.” Further the indicia element 18 can comprise any word or any symbol, logo, or pattern, including a single line or plurality of lines.

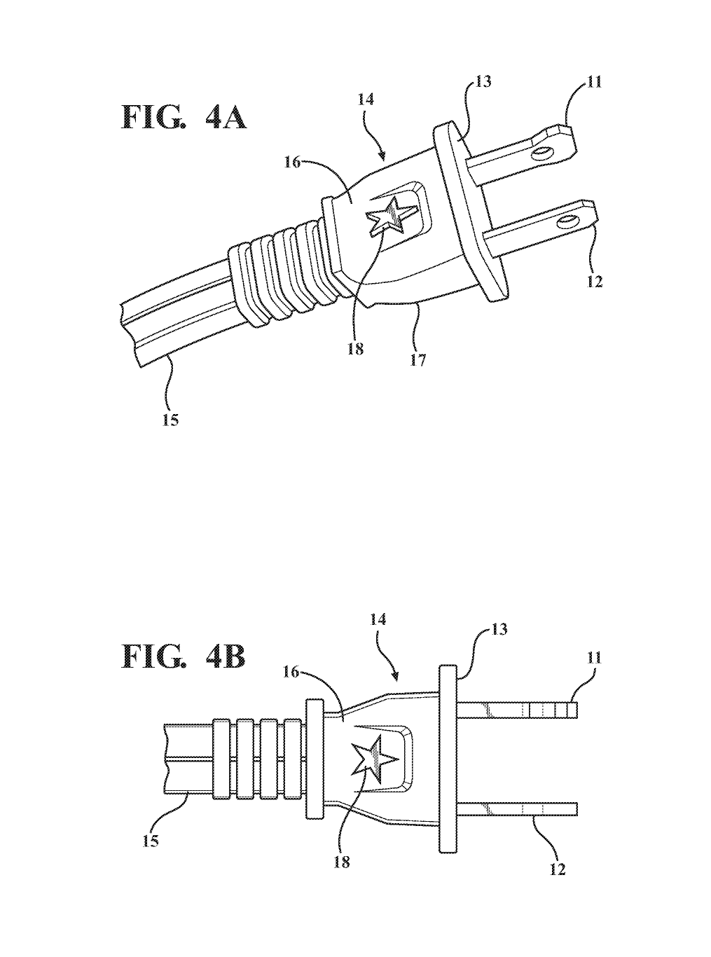

FIG. 4A is a perspective view of a two-prong polarized electrical plug according to another embodiment of the present invention. FIG. 4B is a top planar view of the electrical plug of FIG. 4A.

The two-prong polarized electrical plug of FIGS. 4A and 4B is generally similar to the two-prong polarized electrical plug of FIGS. 2A-2B and 3A-3B, except the indicia element 18 is formed so as to project outward from the surface of the plug housing and can be form by molding. In this embodiment the indicia element 18 can be the same or a different color than the plug housing.

The indicia element 18 in FIGS. 4A and 4B is in the shape of a star.

It is to be understood that the star shape shown in FIGS. 4A and 4B is for non-limited illustrative purposes only and the shape of the indicia element 18 is not limited to the star shape.

In other embodiments the indicia element 18 can have any shape such as an arrow, a circle, plus sign, etc. Further the indicia element 18 can comprise any word or any symbol, word, logo, or pattern, including a single line or plurality of lines.

Having the indicia project out of or be recessed in the top surface of the plug housing can enable a visually impaired person to “feel” the indicia and confirm the orientation of the plug. Otherwise such projecting or recessed indicia can be used to “feel” the top of the plug when inserting the plug into an outlet or receptacle that is not too accessible such as electrical outlets or receptacles that are difficult to access, such as behind furniture or under a table.

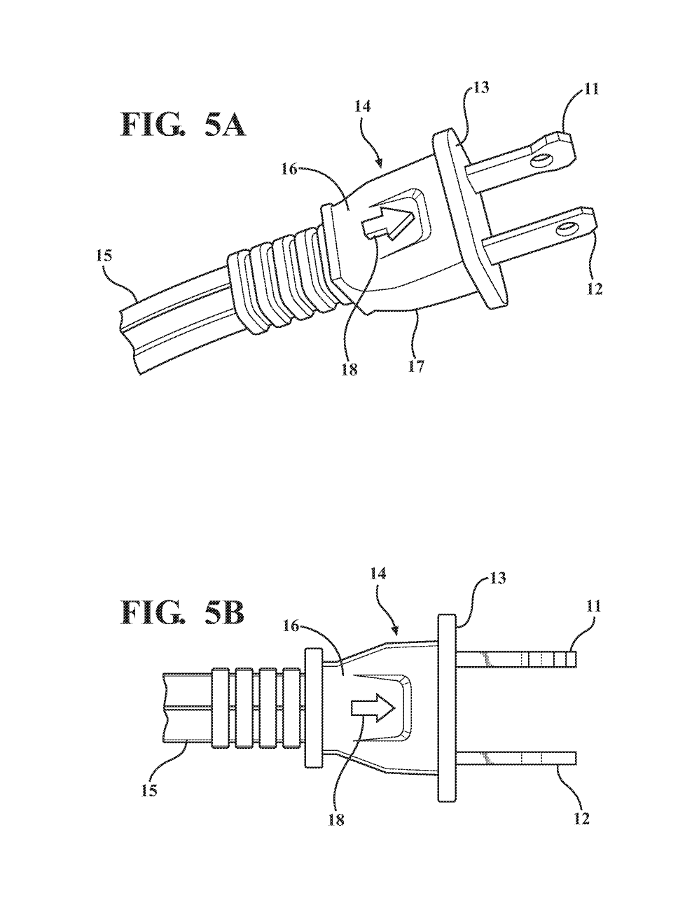

FIGS. 5A and 5B are similar to the embodiment of the invention shown in FIGS. 4A and 4B except they illustrate indicia 18 in the form of an arrow rather than a star. FIGS. 5A-5B illustrate an indicia that, in addition to identifying the top of the plug or plug housing for purposes of orientation provide identification of the front of the plug which. This can be useful for situations when it is difficult to clearly see the plug or indicia due to poor sight and/or poor lighting. Other indicia that can be used to assist in identifying the front orientation of the plugs or plug housings include brail marks, lines, words, triangles, etc.

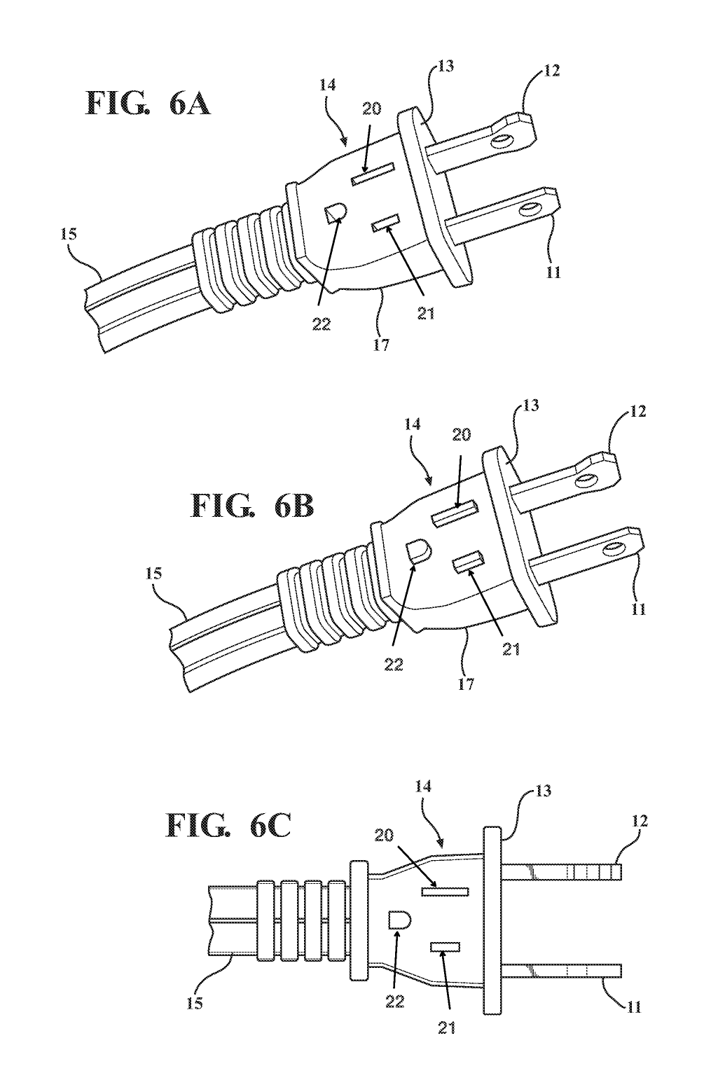

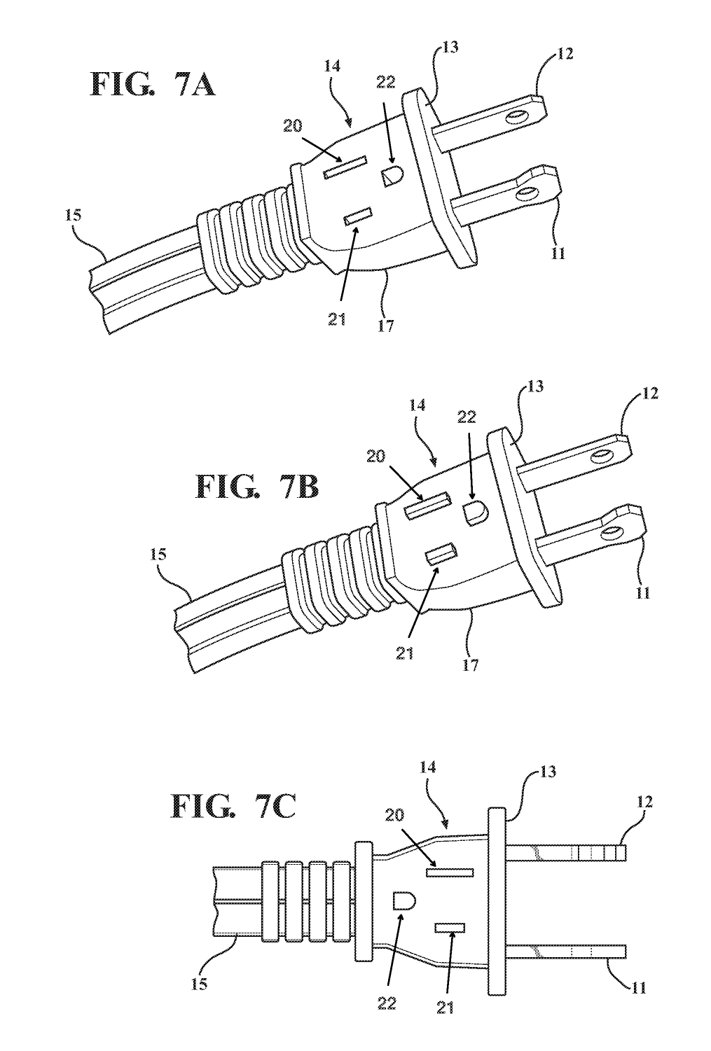

FIGS. 6A-6C are top views of a plug that is designed to be used in conjunction with electrical outlets or receptacles having grounding sockets oriented either downward or upward. FIGS. 7A-7C are bottom views of the plug of FIGS. 6A-6B.

The embodiment of the invention shown in FIGS. 6A-7C illustrates plugs that have indicia on both the top and bottoms of the plug housings. Providing different indicia on the top and bottom surfaces of the plug housing can enable verification of the orientation of the polarized and non-polarized prongs or blades. Such verification ability can allow a single plug design to be properly used in conjunction with electrical outlets or receptacles that have their grounding sockets oriented either upward or downward.

FIGS. 6A-6C depict indicia that is provided on a side of the plug housing 14 that faces upward when the two-prong polarized plug is oriented to be into an electrical outlet or receptacle having a grounding socket that is located in a downward or lower position. In such an embodiment the polarized prong or blade 11 is located on the left side as illustrated.

The indicia shown in FIGS. 6A-6C includes two parallel elongated rectangular elements 20 and 21, and an elongated half-circle 22. The configuration of the elongated rectangular elements 20, 21 and elongated half-circle 22 of the indicia corresponds to the pattern of the polarized, non-polarized and grounding sockets of an electrical outlet or receptacle into which the plug can be inserted.

FIGS. 7A-7C depict indicia that is provided on a side of the plug housing 14 that faces upward when the two-prong polarized plug is oriented to be into an electrical outlet or receptacle having a grounding socket that is located in an upward position. In such an embodiment the polarized prong or blade 11 is located on the right side as illustrated.

According to one embodiment of the present invention the indicia shown in FIGS. 6A-6C and 7A-7C are provided on opposite sides of the same plug housing so that the resulting plug can be used in conjunction with an electrical outlet or receptacle either having a grounding socket located in an upward or downward position, by matching the indicia pattern to the pattern of the polarized, non-polarized and grounding sockets of an electrical outlet or receptacle into which the plug can be inserted.

It is to be understood that the indicia in FIGS. 6A-7C form a pattern that is intended to be similar to the pattern of the polarized, non-polarized and grounding sockets of an electrical outlet or receptacle into which the plug can be inserted. In this regard one of the elongated rectangular elements 20, 21 which represents the polarized socket of an electrical outlet or receptacle is longer than the other elongated rectangular element. It is to be understood that other indicia having a pattern that is intended to be similar to or easily/readily associated with the pattern of the polarized, non-polarized and grounding sockets of an electrical outlet or receptacle can include elongated rectangular elements that are of the same length, a circular rather than a half-circular element 22, or any other configuration a user could associate and match or associate with the pattern of the polarized, non-polarized and grounding sockets of an electrical outlet or receptacle such as an arrow pointing forward to a dot or an arrow pointing backward to a dot in which instance the dot will represent the position of a grounding socket of an electrical outlet or receptacle. As shown the indicia or indicia pattern on one side of the plug housing is basically inverted on the opposite side of the plug housing.

FIGS. 6A and 7A illustrate an embodiment in which the indicia, including the elongated rectangular elements 20 and 21, and half-circle element 22 are recessed into the plug housing 14. FIGS. 6B and 7B illustrate an embodiment in which the indicia, including the elongated rectangular elements 20 and 21, and half-circle element 22 project out from the surface of plug housing 14. FIGS. 6C and 7C illustrate a top view of the indicia pattern.

In further embodiments the indicia in FIGS. 6A-7C can be printed, colored, laminated, etc. as noted in the other embodiments of indicia mentioned herein.

The advantage of the embodiment of the invention depicted in FIGS. 6A-7C is that a single plug design can be used with electrical outlets or receptacles having lower positioned grounding sockets (sometime used in residential installations) or electrical outlets or receptacles having upper positioned grounding sockets (sometimes used in commercial installations).

In embodiments of the invention described above the indicia can be provided on the top of the plug housing and the bottom of the plug housing can be free of any indicia. In alternative embodiments the bottom of the plug housing could be provided with indicia that provides the user with a means to identify the bottom of the plug. For example the top of the plug could be provided with a plus sign (“+”) or other symbol and the bottom could be provided with a negative (“−”) sign or other symbol. Or the top could be provided with a green indicia and the bottom could be provided with a red indicia (indicating a warning). In other embodiments the top of the plug can be provided with an indicia that reads “UP” and the bottom could be provided with an indicia that reads “DOWN.” These are non-limited examples that those skilled in the art can easily expand upon based upon the present description.

The indicia described above can be used individually or in combination. For example indicia that is recessed in (See FIG. 3A) or projects (See FIG. 4A) from the top surface of a plug housing can be the same or a different color than the plug housing 14. Or a combination of an indicia that is recessed in part and projects in part from the top surface of a plug housing could be used. These are non-limited examples of combinations that those skilled in the art can easily expand upon based upon the present description.

The indicia used in the present invention should be of a size and configuration to be easily seen from a distance of 6-8 feet or more so that one can visibly verify the orientation of a plug after it has been plugged into an electrical outlet or receptacle from a standing position. In this regard if the color of the indicia and plug housing are not the same a dimension of the indicia should be about 5 mm or larger for a solid indicia or about 25% or greater of a corresponding dimension of the plug housing and about 33% or greater of a corresponding dimension of the plug housing so as to be easily visible. In the case of an indicia that is not solid, such as a line drawing or a projecting or a recessed lines or a line drawing, the width of the lines should be at least 2 mm or greater with the overall shape of any line drawing being about 25% or greater of a corresponding dimension of the plug housing and about 33% or greater of a corresponding dimension of the plug housing, or even about 50% or greater. In some embodiments the overall shape of the indicia is different from the overall shape of the plug housing. In further embodiments the indicia is laminated into or onto the plug housing or otherwise attached to the plug housing and can include two- and three-dimensional indicia. Examples of three-dimensional indicia include real and synthetic gems including gem stickers or any small three-dimensional object.

The two-prong electrical plugs of the present invention are particularly safe for use by young children who will not have to be concerned with handing the prongs or blades trying to determine the polarized prong or blade from the non-polarized prong or blade. Further the use of recessed or projecting indicia can be particularly useful for persons with poor eyesight or blind and in poor lighting conditions in conjunction with electrical outlets or receptacles that are difficult to access, such as behind furniture or under tables. It is even within the scope of the present invention to provide brail as indicia.

In alternative embodiments the present invention provides for two-prong electrical plug adaptors that have any of single or any combination of the indicia described above. The plug adaptors allow for retrofitting existing two-prong electrical plugs with the visible indicia described above that assists in orienting such plugs with respect to polarized electrical receptacles and being able to verify proper orientation and safety of such plugs with respect to polarized electrical receptacles and outlets after the plugs are plugged into such receptacles and outlets.

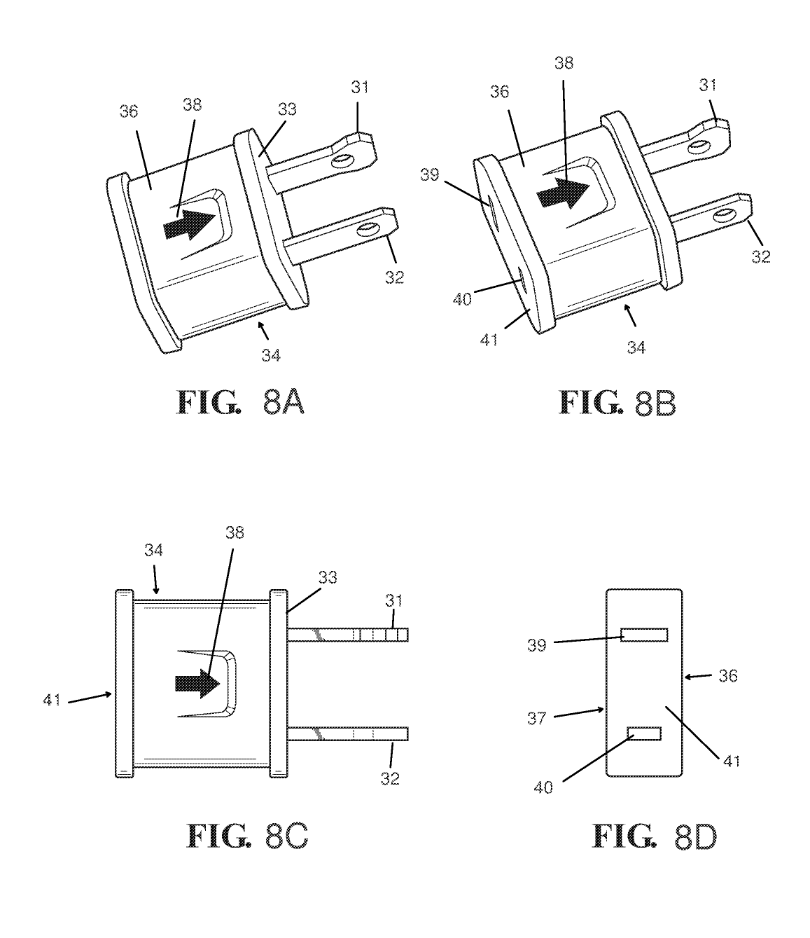

FIG. 8A is a perspective view showing the front side of a two-prong polarized electrical plug adaptor according to one embodiment of the present invention. FIG. 8B is a perspective view showing the back side of a two-prong polarized electrical plug adaptor of FIG. 8A. FIG. 8C is a top planar view of the electrical plug adaptor of FIGS. 8A and 8B. FIG. 8D is a planar view of the back side of the electrical plug adaptor of FIGS. 8A-8C.

The body 34 of the plug adaptor includes a back side or face 41 a front side or face 33 and a polarized prong or blade 31 and a non-polarized prong or blade 32 extending outward from a front side face 33 of the body 34. The body 34 of the plug adaptor further includes a top 36 and bottom 37. As used herein “top” refers to the area or surface of the plug adaptor that would be the uppermost area or surface when the adaptor is inserted correctly into a properly installed polarized wall mounted electrical outlet or receptacle. In one embodiment often associated with residential housing wall mounted electrical outlets or receptacles are installed with their grounding sockets toward the bottom. In such embodiments correct insertion of the plug adaptor would have the polarized (wider) prong or blade on the left side when viewing the plug from the back toward the front. According to another embodiment often associated with commercial facilities wall mounted electrical outlets or receptacles are installed with their grounding sockets toward the top. In such embodiments correct insertion of the plug adaptor would have the polarized (wider) prong or blade on the right side when viewing the plug adaptor from the back toward the front.

The back side 41 of the body 34 of the plug adaptor has a polarized socket 39 and a non-polarized socket 40 formed therein which are configured to receive the prongs or blades of a standard two-prong polarized electrical plug therein. The conductive elements or contacts provided within the body 34 of the plug adaptor conductively connect the polarized socket 39 to the polarized blade or prong 31 and the non-polarized socket 40 to the non-polarized blade or prong 32. Such conductive elements or contacts can be of conventional design, for example, similar to the conductive elements or contacts found in a standard 3-prong to 2-prong plug adaptor such as model No. ACS100 sold by Eagle Aspen, and other manufactures.

An indicia element 38 is provided on (or in) the top of the body 34 of the plug adaptor which functions to confirm the orientation of the plug adaptor both while inserting the plug adaptor into a polarized outlet receptacle and to enable confirmation of proper orientation after the plug adaptor has been inserted into a polarized electrical outlet or receptacle, for example when a prior user has inserted the plug adaptor into an electrical outlet or receptacle.

As noted above any embodiments of the indicia discussed in general above and in reference to FIGS. 2A-7C can be provided on and/or in the body 34 of the plug adaptor of FIGS. 8A-8D to provide visual confirmation of proper orientation of the plug adaptor with respect to a polarized electrical receptacle or outlet before and after the plug adaptor is plugged into the outlet, including but not limited to indicia on the top and/or bottom of the plug adaptor.

It is to be understood that the body of the plug adaptor is not limited to the shape depicted in FIGS. 8A-8D so long as the blades or prongs are properly oriented and extend from the front of the body and the sockets are properly oriented in the back of the body and an indicia element is provided so as to identify the proper orientation of the plug adaptor.

In use a standard two-prong polarized electrical plug is plugged into the back of the plug adaptor by inserting the blades or prongs of the electrical plug into the sockets provided in the back of the plug adaptor. After this coupling of the electrical plug with the plug adaptor the indicia element can be used to ensure proper orientation of both the plug adaptor and electrical plug coupled thereto into an electrical outlet of receptacle.

In use plug adaptor of the present invention can be coupled to a standard two-prong polarized electrical plug that is attached to an extension cord, a lamp cord, radio chord or any other type of electrical appliance or device.

As can be appreciated the plug adaptors of the present invention can retrofit preexisting household electrical appliances and devices without having to replace their original plugs. This makes the plug adaptors particularly useful for persons with bad eyesight and/or bind people who can attach a plug adaptor having a projecting and/or recessed indicia that can be easily felt to their existing electrical appliances and devices.

The prongs or blades 31 and 32 can be made from any conventional conductive metal such as brass and the plug body 34 can be made (e.g. molded) from any conventional non-conductive material such as a plastic material.

According to further embodiments of the present invention the plug adaptors of FIGS. 8A-8D could be marked with different indicia, including but not limited to different color indicia and used to readily identify what appliances are associated with a plug that is coupled to the plug adaptors. Further encompassed is the use of fully or partially colored or labeled plug adaptors that can be used to readily identify what appliances are associated with a plug that is coupled to the plug adaptors. For example the plugs of emergency devices couple be coupled to red colored plug adaptors, ventilator equipment in hospitals could be coupled to blue colored plug adaptors, etc. Electrical systems that include multiple electrical devices could use different colored plug adaptors for each of the electrical devices with similar colored plug adaptors for similar electrical devices. The indicia could further include drawings or images of the electrical devices associated with a plug that is coupled to the plug adaptors. The colored plug adaptors could be provided with or without indicia that identifies the tops or bottoms of the plugs.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above and set forth in the attached claims.

1. A polarized electrical plug adaptor configured to be coupled to a polarized two-prong electrical plug which polarized electrical plug adaptor provides for visual confirmation of proper orientation with respect to a polarized electrical receptacle or outlet before and after being plugged into the outlet and which polarized electrical plug adaptor comprises:
a body having a top and a bottom and a front and a back;
an electrically conductive polarized prong or blade that extends outward from the front of the body;
an electrically conductive non-polarized prong or blade that extends outward from the front of the body;
a polarized socket provided in the back of the body;
a non-polarized socket provided in the back of the body, said polarized socket and non-polarized socket being configured to receive a two-prong polarized electrical plug therein;
electrical conductive elements within the body that connect the polarized socket to the polarized prong or blade and connect the non-polarized socket to the non-polarized prong or blade; and
an indicia element provided on the top of the body which provides visual confirmation of proper orientation with respect to a polarized electrical receptacle or outlet before and after being plugged into the outlet.

2. A polarized electrical plug adaptor provides for visual confirmation of proper orientation with respect to a polarized electrical receptacle or outlet before and after being plugged into the outlet according to claim 1, wherein, absent the indicia element the top and bottom of the body look substantially identical.

3. A polarized electrical plug adaptor that provides for visual confirmation of proper orientation with respect to a polarized electrical receptacle or outlet before and after being plugged into the outlet according to claim 1, wherein the top of the body faces upward when polarized and non-polarized prongs or blades are horizontally aligned and polarized prong or blade on the left side when viewing the plug housing from a back of the body toward the front of the body.

4. A polarized electrical plug adopter that provides for visual confirmation of proper orientation with respect to a polarized electrical receptacle or outlet before and after being plugged into the outlet according to claim 1, wherein the top of the body faces upward when polarized and non-polarized prongs or blades are horizontally aligned and polarized prong or blade on the right side when viewing the body from a back of the plug housing toward the front face of the body.

5. A polarized electrical plug adaptor that provides for visual confirmation of proper orientation with respect to a polarized electrical receptacle or outlet before and after being plugged into the outlet according to claim 3, wherein the indicia element comprises a colored area or portion of the top of the body that is a different color than the bottom of the body.

6. A polarized electrical plug adaptor that provides for visual confirmation of proper orientation with respect to a polarized electrical receptacle or outlet before and after being plugged into the outlet according to claim 3, wherein the indicia element projects into a surface of the top of the body.

7. A polarized electrical plug adaptor that provides for visual confirmation of proper orientation with respect to a polarized electrical receptacle or outlet before and after being plugged into the outlet according to claim 3, wherein the indicia element projects outward from a surface of the top of the body.

8. A polarized electrical plug adaptor that provides for visual confirmation of proper orientation with respect to a polarized electrical receptacle or outlet before and after being plugged into the outlet according to claim 3, wherein the indicial element comprises a word.

9. A polarized electrical plug adaptor that provides for visual confirmation of proper orientation with respect to a polarized electrical receptacle or outlet before and after being plugged into the outlet according to claim 3, wherein the indicial element comprises a symbol, geometric or non-geometric shape, symbol, logo or pattern.

10. A method of confirming proper orientation of a two prong polarized electrical plug with respect to a polarized electrical receptacle or outlet before and after being plugged into the outlet which method comprises:
providing a two prong polarized electrical plug adaptor comprising:
a body having a top and a bottom and a front and a back;
an electrically conductive polarized prong or blade that extends outward from the front of the body;
an electrically conductive non-polarized prong or blade that extends outward from the front of the body;
a polarized socket provided in the back of the body;
a non-polarized socket provided in the back of the body, said polarized socket and non-polarized socket being configured to receive a two-prong polarized electrical plug therein;
electrical conductive elements within the body that connect the polarized socket to the polarized prong or blade and connect the non-polarized socket to the non-polarized prong or blade; and
an indicia element provided on the top of the body which provides visual confirmation of proper orientation with respect to a polarized electrical receptacle or outlet before and after being plugged into the outlet;
plugging a two-prong polarized plug into the back of the body;
providing a polarized electrical receptacle or outlet; and
visually confirming that the indicia element is pointing upward when and/or after the plug adaptor is inserted into the polarized electrical receptacle or outlet.

9. A method of confirming proper orientation of a two prong polarized electrical plug with respect to a polarized electrical receptacle or outlet before and after being plugged into the outlet according to claim 8, wherein absent the indicia element the top and bottom of the body look substantially identical.

10. A method of confirming proper orientation of a two prong polarized electrical plug with respect to a polarized electrical receptacle or outlet before and after being plugged into the outlet according to claim 9, wherein the indicia element comprises a colored area or portion of the top of the body that is a different color than the bottom of the body.

11. A method of confirming proper orientation of a two prong polarized electrical plug with respect to a polarized electrical receptacle or outlet before and after being plugged into the outlet according to claim 9, wherein the indicia element projects into a surface of the top of the body.

12. A method of confirming proper orientation of a two prong polarized electrical plug with respect to a polarized electrical receptacle or outlet before and after being plugged into the outlet according to claim 9, wherein the indicia element projects outward from a surface of the top of the body.

13. A method of confirming proper orientation of a two prong polarized electrical plug with respect to a polarized electrical receptacle or outlet before and after being plugged into the outlet according to claim 9, wherein the indicial element comprises a word.

14. A method of confirming proper orientation of a two prong polarized electrical plug with respect to a polarized electrical receptacle or outlet before and after being plugged into the outlet according to claim 9, wherein the indicial element comprises a symbol, geometric or non-geometric shape, symbol, logo or pattern.

15. A polarized electrical plug adaptor that provides for visual confirmation of proper orientation with respect to a polarized electrical receptacle or outlet before and after being plugged into the outlet which comprises:
a body having a top and a bottom and a front and a back;
an electrically conductive polarized prong or blade that extends outward from the front of the body;
an electrically conductive non-polarized prong or blade that extends outward from the front of the body;
a polarized socket provided in the back of the body;
a non-polarized socket provided in the back of the body, said polarized socket and non-polarized socket being configured to receive a two-prong polarized electrical plug therein;
electrical conductive elements within the body that connect the polarized socket to the polarized prong or blade and connect the non-polarized socket to the non-polarized prong or blade;
a first indicia element provided on the top of the body which provides visual confirmation of proper orientation with respect to a polarized electrical receptacle or outlet having a lower grounding socket before and after being plugged into the outlet; and
a second indicia element provided on the bottom of the body which provides visual confirmation of proper orientation with respect to a polarized electrical receptacle or outlet having an upper grounding socket before and after being plugged into the outlet.

16. A polarized electrical plug adaptor that provides for visual confirmation of proper orientation with respect to a polarized electrical receptacle or outlet before and after being plugged into the outlet according to claim 15, wherein at least one of the first and second indicia elements comprises a colored area or portion of the top of the body that is a different color than the bottom of the body.

17. A polarized electrical plug adaptor that provides for visual confirmation of proper orientation with respect to a polarized electrical receptacle or outlet before and after being plugged into the outlet according to claim 15, wherein at least one of the first and second indicia elements projects outward from a surface of the body.

18. A polarized electrical plug that provides for visual confirmation of proper orientation with respect to a polarized electrical receptacle or outlet before and after being plugged into the outlet according to claim 15, wherein at least one of the first and second indicia elements is recessed in a surface of the body.

19. A polarized electrical plug adaptor that provides for visual confirmation of proper orientation with respect to a polarized electrical receptacle or outlet before and after being plugged into the outlet according to claim 15, wherein the first and second indicia elements have inverted patterns of one another.

20. A polarized electrical plug adaptor configured to be coupled to a polarized two-prong electrical plug which polarized electrical plug adaptor provides for visual confirmation of proper orientation with respect to a polarized electrical receptacle or outlet before and after being plugged into the outlet according to claim 1 in combination with a two-prong polarized electrical plug that is plugged into the back of the body.
